(19) United States
(12) Patent Application Publication
(10) Pub. No.: US 2008/0011929 A1
(43) Pub. Date: Jan. 17, 2008

(54) Chair & soft floor mount

(76) Inventor: Peter Neville Jennings, Ranger, GA (US)

Correspondence Address: Peter N. Jennings, 396 Long Branch Road, Ranger, GA, 30734, US

(21) Appl. No.: 11/824,764

(22) Filed: Jul. 2, 2007

Related U.S. Application Data
(60) Provisional application No. 60/830,423, filed on Jul. 13, 2006.

(51) Int. Cl. F16M 13/00

(52) U.S. Cl. 248/346.01

(57) ABSTRACT

The ‘chair and sofa floor mount’ is a rigid, angular ‘M’ shaped tool or device. It is made out of a durable material in a manner that will more than support the weight of any typical sofa or recliner.

The centre of the ‘M’ is the seat for the ‘chair’ support, approximating 90 degrees at the seat corner. The angles of the supporting sides of this seat define the approximate universal point of equilibrium on which the ‘chair’ will rest. These angles are 50 degrees and 40 degrees measured from vertical, with en estimated tolerance of 2 degrees on either side. The length of these slopes is important to support the ‘chairs’ adequately. These are 5 and 6 inches long. At these lengths the ‘mount’ will support all low backed chairs with a clearance of around 7 inches from the floor to the body of the chair.

The general size of the ‘mount’ can vary to suit the material, application or height required, but the angles of the center of the seat should remain constant relative to the floor surface.

This application claims the benefit of provisional patent application Ser. No. US60/830,423 granted Jul. 27, 2006

### FEDERALLY SPONSORED SEARCH

Not applicable

### SEQUENCE LISTING

Not applicable

### 1. BACKGROUND OF THE INVENTION

1. Field of Invention

My chair and sofa floor mount relates to household cleaning equipment and accessories, specifically to floor and carpet cleaning.

2. Prior Art

Commonly low backed sofas, chairs and recliners (hereinafter referred to as ‘chairs’) have to be moved around before and while cleaning the floor. The nature of these ‘chairs’ is that the area beneath them is inaccessible for cleaning. When shampooing carpets these ‘chairs’ are required to be moved out of the room. This implies additional workload and risk, plus potential storage problems if space is limited and drying times are extended. Replacing these ‘chairs’ before the carpets are dry can lead to mould problems that are a health hazard to the home.

This labor intensive approach to moving heavy chairs is time consuming and archaic. Not only is there a risk of back injury from lifting and moving these chairs, but a general inconvenience of inaccessibility due to their weight. Not cleaning under these ‘chairs’ can cause serious allergen problems. (Tests conducted in Canada and the USA have found that living rooms have high allergen levels.)

The market has not yet attempted to address this common household problem other than through conventional cleaning equipment. The challenge is to offer a cost effective universal tool that would provide an efficient solution to these problems for all floor surfaces.

There is no prior art for this type of application.

3. Objects and Advantages

Cleaning floors can entail strenuous effort, specifically in respect to moving heavy ‘chairs’. It is also time consuming and tiring. The problem is that if certain areas are not cleaned as a result, there is a health hazard to the home.

Accordingly, there are several objects and advantages of the chair and sofa floor mount invention whereby it:
a) provides a means for clearing the floor quickly for cleaning purposes without the ongoing moving of heavy ‘chairs’;
b) acts as a universal tool with a simple mechanism for elevating the ‘chair’ in situ adequately off the floor surface to facilitate easy access underneath for cleaning;
c) works on all floor surfaces;
d) is durable and can support the heaviest of ‘chairs’;
e) can support the ‘chair’ for an extended period to facilitate drying time;
f) provides a means for reducing back-strain associated with lifting heavy objects,
g) provides a means for one person to complete this task.

### 2. SUMMARY

In essence, the chair and sofa floor mount provides the unique ability for cleaners to clear the floor surface quickly and easily without having to move heavy ‘chairs’ around. This is a universal tool that works on all low backed chairs, sofas and recliners on any floor surface. It allows ‘chairs’ to remain off the floor surface while the floor or carpets are cleaned and drying.

This mount is a rigid angular stand on which the ‘chair’, tilted backwards, stands in an elevated position of equilibrium. This position is defined by the mount from the supporting slopes adjacent angles to the 90 degree seat in which the feet of the ‘chair’ rest.

### 3. DESCRIPTION OF THE CHAIR AND SOFA FLOOR MOUNT

My chair and sofa floor mount is a tool that is placed under the back feet or the rear base of the ‘chair’, and which elevates and supports it at a backward tilt at the approximate equilibrium point. This allows easy elevation of the chair to facilitate access underneath. It is designed to be used as a cleaning aid and can also be used for storage.

It provides the means for elevating and supporting all ‘low backed’ chairs at a backward tilt at the approximate equilibrium point. ‘Low backed’ chairs are defined as having a maximum clearance of 7 inches from the floor. Sofas and recliners inherently fall within this category.

### DRAWINGS—FIGURES

FIG. 1 Top view

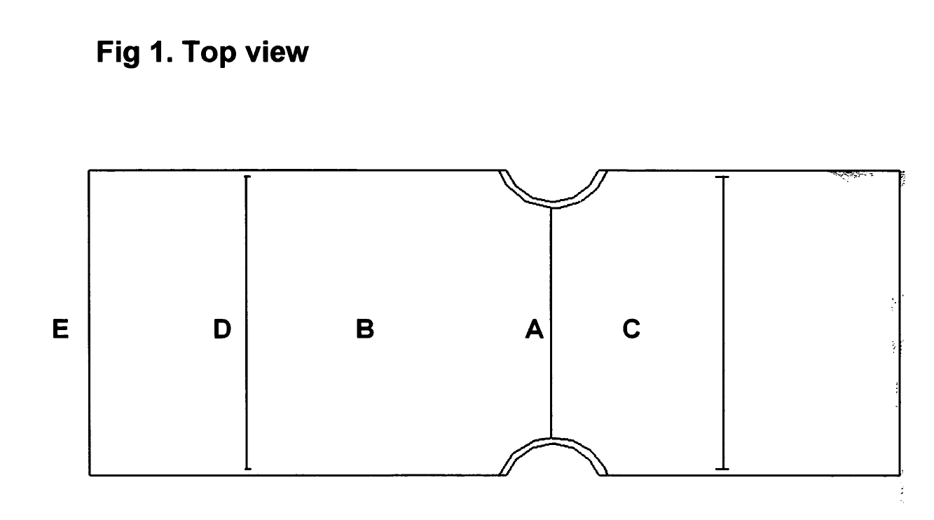

FIG. 2 Side view

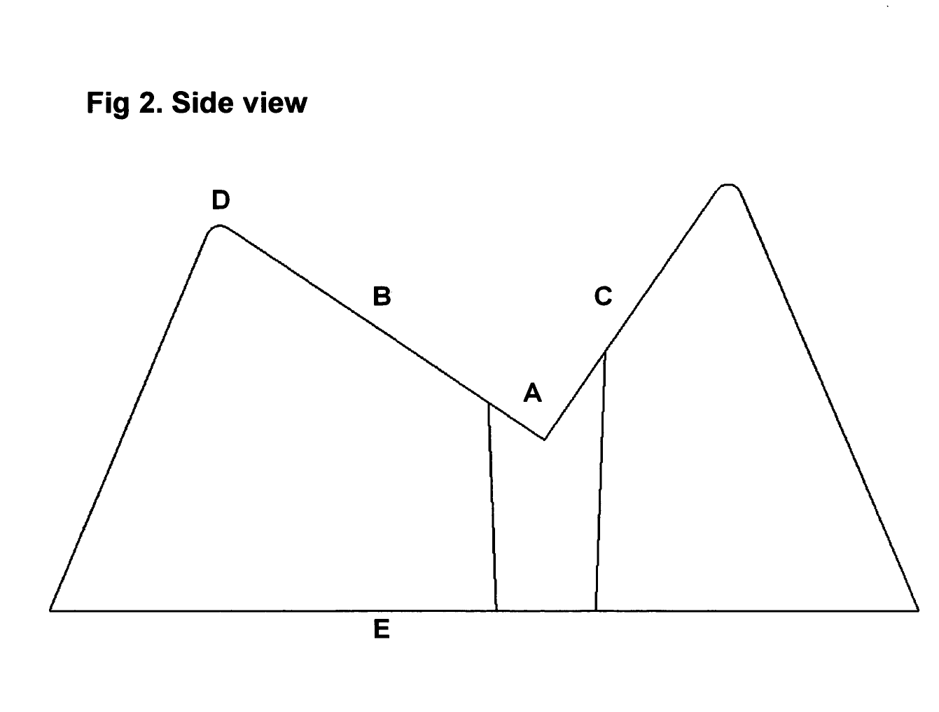

FIG. 3 Isometric view

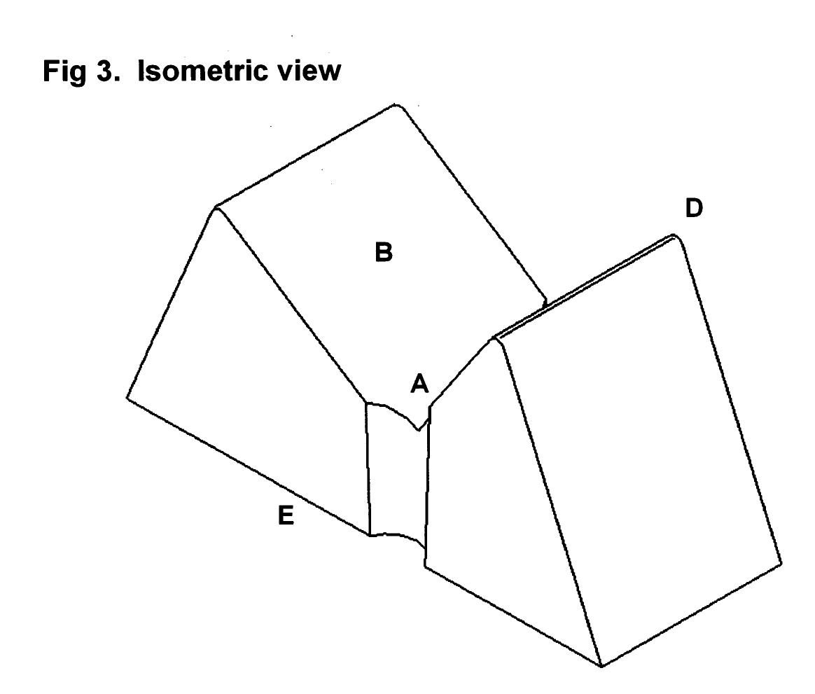

FIG. 4 Isometric picture

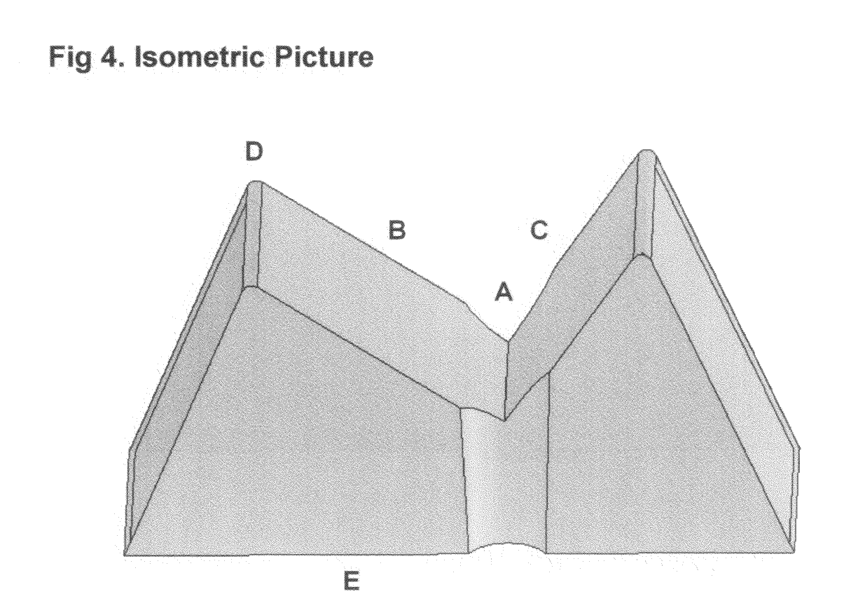

### LEGEND

A This is the ‘seat’ of the mount which approximates 90 degrees. The rear corner of the base of the chair fits into this area.
B This is the longer slope on which the back of the ‘chair’ rests.
C This is the steep slope that faces towards the front of the ‘chair’. It supports the foot of the ‘chair’.
D The top edges are filleted or rounded.
E This is the base of the mount that rests on the floor surface.

This drawing was designed for vacuum formed production. The type of production used could change the structure, but not the overall design. Injection molding would be less solid in appearance, but more structurally integrated.

The critical aspect of my invention are the angles of equilibrium in which the back corner of the ‘chair’ resides. These angles form the unique universal pitch that supports the ‘chairs’ at the approximate point of equilibrium. The feet of the ‘chair’ rest in the seat (A), or middle, of the mount. The adjacent slopes (i), designed at the angles required for equilibrium, provide support for the ‘chair’ at its base.

The angular ‘M’ design of the mount allows for strength and leverability, and minimizes slippage on the floor surface. The base (E), about 6 inches wide, tapers to around 5.5 inches at the top. The overall length is around 13 inches. The middle of the tool has a valley between two peaks, the seat of which approximates 90 degrees (A). Both slopes from this seat point are at specified angles that approximate the equilibrium point of the chair when tilted onto its back feet (B,C). Each of the slopes is a specified length to suit the minimum clearance of 7 inches of the low backed chairs. The distance from the ‘seat’, or 90 degree corner, is approximately 3 inches from the floor surface. (A to E)

The general size can vary to suit the application or height required, but the proportions and design will remain the similar. The tool needs to be rigid to support the weight and the correct angle of the ‘chair’.

### 4. OPERATION

The ‘chair’ is tilted forward slightly, and a ‘mount’ is placed under both feet at the rear of the ‘chair’. The steep angle (C) of the inner slope faces the front of the ‘chair’. Then the ‘chair’ is tilted backwards into the equilibrium position. If the sofa is large, each side is lifted separately and a ‘mount’ placed under each of the rear feet. The rear feet of the ‘chair’ now sit in the right angled seat of the ‘mount’. The ‘chair’ is then tilted back to the point at which it comes to rest, with its base a few inches off the floor. This will be the approximate position of equilibrium, allowing the ‘chair’ to sit securely in this state.

To remove, simply tilt forward again and remove the two mounts.

### 5. ADVANTAGES OF THIS INVENTION

From the description above, a number of advantages of my ‘chair and sofa floor mount’ become evident whereby:
a) ‘Chairs’ can quickly and easily be elevated ‘in situ’ to facilitate a clear cleaning area under and around its base.
b) The process is simple and utilizes leverage, thus requiring less effort and strength than moving or lifting the ‘chairs’ for cleaning. Areas can now be cleaned that were previously inaccessible or difficult for one person to clean.
c) ‘Chairs’ can remain in this elevated position while floors or carpets dry. No further effort is required other than to dismount the chair when finished.
d) The risk of moving heavy ‘chairs’ is virtually eliminated, from an injury perspective and furniture damage.
e) The tool is universally effective on all standard production low backed chairs, sofas and recliners.
f) The tool is effective on all floor surfaces.

### 6. CONCLUSION, RAMIFICATIONS AND SCOPE

Accordingly the reader will see that, based on the specification details set out above, this invention provides a unique solution to a common household floor cleaning problem.

While the above description contains specifics, these should not be construed as limitations to the scope of the invention, but as exemplifications of the presently preferred embodiments thereof. Other variations are possible within the principle of this invention. For example, the product could be adapted for specific types of chairs. Recliners have a narrow steel frame base. The design could be tailored to be narrower with an indent for the frame to fit into.

Thus the scope of the invention should be determined by the appended claims and their legal equivalents, and not by the examples given.

1. A universal tool or mount comprising:
a) a rigid angular shaped form
which provides the means for elevating and supporting all low backed chairs off the floor surface.
